(19) United States
(12) Patent Application Publication
(10) Pub. No.: US 2021/0216970 A1
(43) Pub. Date: Jul. 15, 2021

(54) BEST-FITTING MEETING TIME PREDICTION

(71) Applicant: INTERNATIONAL BUSINESS MACHINES CORPORATION, Armonk, NY (US)

(72) Inventors: Reinhold GEISELHART, Rottenburg-Ergenzingen (DE); Alexander LANG, Stuttgart (DE); Verena HENRICH, Griesheim (DE); Magdalena LESHTANSKA, Leinfelden-Echterdingen (DE)

(21) Appl. No.: 16/743,490

(22) Filed: Jan. 15, 2020

(51) Int. Cl. G06Q 10/10; G06N 7/00

(52) U.S. Cl. CPC G06Q 10/1095; G06N 7/005

(57) ABSTRACT

Methods and systems for best-fitting meeting time prediction by ad-hoc ensemble creation for personalized classification with a group scope are disclosed. A computer-implemented method includes: receiving, by a computing device, a request to determine a timeslot for a meeting, the request including a plurality of invitees and information about a meeting requester; reading, by the computing device, for each of the plurality of invitees, information about currently scheduled meetings and a profile including a weight assigned to the meeting requester; determining, by the computing device, for each of a plurality of candidate timeslots, an ensemble value for the candidate timeslot based on the information about the currently scheduled meetings and the weight assigned to the meeting requester for each of the plurality of invitees; and selecting, by the computing device, the timeslot for the meeting based on the ensemble values for the candidate timeslots.

### BACKGROUND

Aspects of the present invention generally relate to computing devices and, more particularly, to methods and systems for best-fitting meeting time prediction by ad-hoc ensemble creation for personalized classification with a group scope.

A calendar system may offer the ability to find a best meeting time for a new meeting to be scheduled based on the availability of potential meeting participants as reflected in the calendar system. Information about the availability of potential meeting participants may be enhanced with history information stored in a user's calendar regarding the potential meeting participants' attendance at previous meetings. A calendar system may make a prediction regarding a potential meeting participant's participation in a new meeting based on availability information stored in and retrieved from the calendar system.

### SUMMARY

In a first aspect of the invention, there is a computer-implemented method that includes: receiving, by a computing device, a request to determine a timeslot for a meeting, the request comprising a plurality of invitees and information about a meeting requester; reading, by the computing device, for each of the plurality of invitees, information about currently scheduled meetings and a profile comprising a weight assigned to the meeting requester; determining, by the computing device, for each of a plurality of candidate timeslots, an ensemble value for the candidate timeslot based on the information about the currently scheduled meetings and the weight assigned to the meeting requester for each of the plurality of invitees; and selecting, by the computing device, the timeslot for the meeting based on the ensemble values for the candidate timeslots.

In another aspect of the invention, there is a computer program product that includes a computer readable storage medium having program instructions embodied therewith. The program instructions are executable by a computing device to cause the computing device to: receive a request to determine a timeslot for a meeting, the request comprising a plurality of invitees and information about a meeting requester; for each of the plurality of invitees, read information about currently scheduled meetings and a profile comprising a weight assigned to the meeting requester; for each of a plurality of candidate timeslots, determine an ensemble value for the candidate timeslot based on the information about the currently scheduled meetings and the weight assigned to the meeting requester for each of the plurality of invitees; and display, in a user interface, an indication of a meeting participation probability for each of the plurality of candidate timeslots based on the ensemble values.

In another aspect of the invention, there is a system that includes: a hardware processor, a computer readable memory, and a computer readable storage medium associated with a computing device; program instructions to receive a request to determine a timeslot for a meeting, the request comprising a plurality of invitees and information about a meeting requester; program instructions to read, for each of the plurality of invitees, information about currently scheduled meetings and a profile comprising a weight assigned to the meeting requester; program instructions to determine, for each of a plurality of candidate timeslots, an ensemble value for the candidate timeslot based on the information about the currently scheduled meetings and the weight assigned to the meeting requester for each of the plurality of invitees; and program instructions to select the timeslot for the meeting based on the ensemble values for the candidate timeslots, wherein the program instructions are stored on the computer readable storage medium for execution by the hardware processor via the computer readable memory.

### BRIEF DESCRIPTION OF THE DRAWINGS

Aspects of the present invention are described in the detailed description which follows, in reference to the noted plurality of drawings by way of non-limiting examples of exemplary embodiments of the present invention.

FIG. 1 depicts a computer system in accordance with aspects of the invention.

FIG. 2 depicts an illustrative environment in accordance with aspects of the invention.

FIG. 3 depicts a flowchart of an exemplary method performed in accordance with aspects of the invention.

FIGS. 4 and 5 depict a conventional system for selecting a meeting timeslot.

FIGS. 6 and 7 depict determining the relative importance of already accepted meeting invitations, according to an embodiment.

FIG. 8 depicts determining ensemble probabilities, according to an embodiment.

FIG. 9 depicts selecting a timeslot based on ensemble probabilities, according to an embodiment.

FIGS. 10, 11, and 12 depict determining ensemble probabilities, according to embodiments.

### DETAILED DESCRIPTION

Aspects of the present invention generally relate to computing devices and, more particularly, to methods and systems for best-fitting meeting time prediction by ad-hoc ensemble creation for personalized classification with a group scope. As described herein, aspects of the invention include a method and system for improved meeting attendance prediction using information including organizational structure (i.e., roles and responsibilities between meeting participants and the meeting requester), required contributions to the success of the meeting by an invitee, and individual perception about the personal impact and value of a meeting which is scheduled by a specific meeting requester.

Calendar systems may make a prediction regarding a potential meeting participant's participation in a new meeting based on availability information stored in and retrieved from the calendar system. However, a free timeslot in a potential meeting participant's calendar does not guarantee his or her participation in a new meeting. On the other hand, an occupied timeslot does not exclude participation by a potential meeting participant in all cases. Additionally, history information stored in a user's calendar regarding the potential meeting participants' attendance at previous meetings is not necessarily a good predictor for future meetings as interests and priorities of meeting participants may change.

Embodiments address these problems with calendar systems by providing methods and systems for best-fitting meeting time prediction by ad-hoc ensemble creation for personalized classification with a group scope. In particular, embodiments improve the functioning of a computer by providing methods and systems for improved meeting attendance prediction using information including organizational structure (i.e., roles and responsibilities between meeting participants and the meeting requester), required contributions to the success of the meeting by an invitee, and individual perception about the personal impact and value of a meeting which is scheduled by a specific meeting requester. Accordingly, through the use of rules that improve computer-related technology, implementations of the invention allow computer performance of functions not previously performable by a computer. Additionally, implementations of the invention use techniques that are, by definition, rooted in computer technology (e.g., ad-hoc ensemble creation, a customer relationship management (CRM) system, and a lightweight directory access protocol (LDAP) system).

In embodiments, methods and systems for best-fitting meeting time prediction determine three major driving factors and areas which contribute to the likelihood of participation in a requested meeting: (1) the organizational structure including roles and responsibilities between the inviter and the invitee; (2) the amount and necessity of contributions to the success of a meeting which an invitee has to deliver, and (3) the positive or negative impact on the invitee which an accept or decline could have. In embodiments, meeting attendance prediction is improved by using additional information outside of a state-of-the-art calendaring system, such as organizational structure (i.e., roles and responsibilities between meeting participants and the meeting requester), the required contributions to the success of the meeting of an invitee, and individual perception about the personal impact and value of a meeting which is scheduled by a specific meeting requester.

In particular, in embodiments, methods and systems determine the organizational structure based on an organizational chart (e.g., an organizational directory, a CRM system, an LDAP system, etc.). Examples of roles and responsibilities included in the organizational structure that have an influence on the likelihood of participation are: “is my boss”, “is reporting to me”, “is working with me on same project (peer)”, “is my customer (I'm advocate of)”, etc.

Additionally, in embodiments, methods and systems determine the amount and necessity of contributions to the success of a meeting which an invitee has to deliver based on a subjective view which the meeting requester has on the invitees and which leads to the meeting requester's decision as to which invitees are needed for a successful meeting. In most cases, the selected invitees also have an understanding as to why they are needed for a particular meeting and then assign an appropriate priority to the meeting invitation. Accordingly, while the amount and necessity of contributions to the success of a meeting which an invitee has to deliver is determined by the meeting requester, it is “reflected” by the invitees.

Additionally, in embodiments, methods and systems determine the positive or negative impact on the invitee which an accept or decline could have based on a subjective view of the invitee (e.g., based on a measure of how participation or decline of the requested meeting would be of personal impact). In particular, when predicting a likelihood of meeting attendance of one or more invitees regarding a meeting requested by a particular requester, embodiments start with determining free times in a calendar but then include additional information from outside of the calendaring system and perform additional calculations to determine a more accurate prediction about the meeting participation, as described below.

In embodiments, contributing factors of the above-described three driving factors and areas which contribute to the likelihood of participation are mapped to weights, and weighting information is stored in individual calendar profiles. In particular, a first set of weights is assigned based on organizational relationships. These may be used as initial defaults for each participant's calendar profile. Higher weights are assigned based on closer organizational relationships (e.g., “is my boss”, “is reporting to me”, or “is working with me on same project (peer)”), and lower weights are assigned based on more distant organizational relationships (e.g., “is not my boss”, “is not reporting to me”, or “is not working with me on same project”).

In embodiments, a second set of weights is assigned based on the meeting requester's view on the need of the invitees' contribution, i.e. how important their contribution is to the success of the meeting. These weights are added to the requester's calendar profile as a weight for each invitee (e.g., “InviteeX=value”). In embodiments, this is done upfront, is valid for a predetermined period of time, and may be adjusted as organizational relationships (e.g., team composition) change.

In embodiments, a third set of weights is assigned based on an invitee's view on the positive or negative impact if he/she participates in or declines meetings scheduled by a particular requester. This is stored in each invitees' calendar profile for each requester as a weight (e.g., “RequesterY=value”). In embodiments, this is done upfront, is valid for a predetermined period of time, and may adjusted as organizational relationships (e.g., team composition) change.

In embodiments, when a new meeting is scheduled by a meeting requester, methods and systems create an ad-hoc ensemble for personalized classification in a group scope with all meeting participants, based on all available weightings from requester's and invitees' calendar profiles. In this way, embodiments determine the likelihood/probability of each invitee's participation in a meeting, for both free as well as already booked timeslots. Based on this, embodiments determine a best-fitting meeting time.

In embodiments, methods and systems extend the functionality of a calendar system by retrieving and involving organizational and participant profile information. On request, a meeting participation likelihood is calculated for each of a plurality of timeslots based on ad-hoc ensemble creation with a group scope and is provided to a meeting requester. In embodiments, a best fitting meeting time is selected based on the meeting participation likelihood for each of the plurality of timeslots, either automatically or by the meeting requester. In embodiments, methods and systems send notifications of the meeting (including accept/decline requests) scheduled for the selected meeting time.

In embodiments, a process is provided for a meeting participation probability calculation. In embodiments, the weights in the invitees' profiles are taken into account. In other embodiments, the weights from the meeting requester's profile are added on top and in addition to the weights in the invitees' profiles. The actual value of the weights is not limited but is positive. Using an affine transformation in the calculation step, the weights are normalized such that they are in the range [0 . . . 1], denoting the probability of participation, normalized across all invitees.

In embodiments, the probability for individual participation by invitees in a meeting to be scheduled is based on the individual invitee's ranking of the importance of this meeting to him/her. In particular, the criteria used are the meeting requester and the assigned personal weight of importance as perceived by the meeting invitee. In embodiments, any number of weighting levels may be used to express a personal ranking of different persons in any desired granularity. In other embodiments, a predetermined small number of ranking levels (e.g., “high”, “normal”, and “low”) are provided, which allow for the desired differentiation but require only minimal effort in setup and adjustment.

In embodiments, Θ is the invitee's weight regarding the personal importance of the requester to him/her, ε is the invitee's weight of an already booked meeting timeslot in the invitee's calendar, and Ψ is the argument of whether the chosen timeslot is free (“1”) or booked (“0”) in the invitee's calendar. In embodiments, a measure to assess the individual invitee's probability for attending a new meeting scheduled by a requester with importance Θ is calculated according to Formula 1:

Θ*Ψ Formula 1

In embodiments, this probability is compared to an analog measure to assess the individual invitee's probability of attending an already booked meeting (if applicable) where the corresponding requester has the importance of ε, which is calculated according to Formula 2:

ε*(1−Ψ) Formula 2

In embodiments, when the new meeting to be scheduled hits a timeslot in the invitee's calendar which is free, then a comparison of Formula 1 and Formula 2 reflects the probability of Formula 1. In case the timeslot is booked already, then a comparison of Formula 1 and Formula 2 reveals whether the invitee would rather accept the new invitation and decline the previous one or keep the previous one and decline the new one. A measure for this is shown by Formula 3, below.

In embodiments, for the situation of finding the best-fitting time for a meeting with multiple participants, the following approach is used, wherein n is the number of invitees for a meeting to be scheduled, i is the index of an individual invitee in the list, Θ is the invitee's weight regarding the personal importance of the requester, ε is the invitee's weight of an already booked meeting in the invitee's calendar, and Ψ is the argument of whether the chosen timeslot is free (“1”) or booked (“0”) in the invitee's calendar. In embodiments, Formula 3 is used to assess the overall likelihood for all invitees (the ensemble) to attend the newly to be scheduled meeting at a free timeslot (if applicable):

$$1 / n {\sum }_{i = 1}^{n} {θ}_{i} * {Ψ}_{i} \qquad Formula 3$$

In embodiments, in the analog case, a measure for the overall likelihood for all invitees to attend an already booked meeting (if applicable) is calculated according to Formula 4:

$$1 / n {\sum }_{i = 1}^{n} {ɛ}_{i} * ( 1 - {Ψ}_{i} ) \qquad Formula 4$$

In embodiments, the overall likelihood of all invitees (the ensemble) to participate in a newly scheduled meeting depends on the delta of Θ=ε for each individual invitee and timeslot to be examined. This is described by Formula 5:

$$1 / n {\sum }_{i = 1}^{n} {θ}_{i} - {ɛ}_{i} * ( 1 - {Ψ}_{i} ) \qquad Formula 5$$

In embodiments, for direct comparison of calendar timeslots, a normalized measure for the probability of all invitees in the new meeting to be scheduled under consideration of possibly already accepted other meetings is calculated according to Formula 6, where LOW is the lowest (positive) value of Θ and ε, HIGH is the highest (positive) value of Θ and ε, LOW≤HIGH and any number of intermediate values of Θ and ε in between (LOW≤ . . . , θₘ, . . . ≤HIGH) and (LOW≤ . . . , εₘ, . . . ≤HIGH):

$$1 / n {\sum }_{i = 1}^{n} \frac{{θ}_{i} - {ɛ}_{i} + HIGH - LOW}{HIGH + HIGH - LOW} \qquad Formula 6$$

In embodiments, the result of Formula 6 ranges from 0 . . . 1 and indicates the overall ensemble probability of all invitees to participate in the newly scheduled meeting in a given timeslot, based on consideration of already booked meetings with individual requester importance.

To the extent the implementations collect, store, or employ personal information of individuals, it should be understood that such information shall be used in accordance with all applicable laws concerning protection of personal information. Additionally, the collection, storage, and use of such information may be subject to advance notification and consent of the individual to such activity, for example, through “opt-in” or “opt-out” processes as may be appropriate for the situation and type of information. Storage and use of personal information may be in an appropriately secure manner reflective of the type of information, for example, through various encryption and anonymization techniques for particularly sensitive information.

The present invention may be a system, a method, and/or a computer program product at any possible technical detail level of integration. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a computer or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be accomplished as one step, executed concurrently, substantially concurrently, in a partially or wholly temporally overlapping manner, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

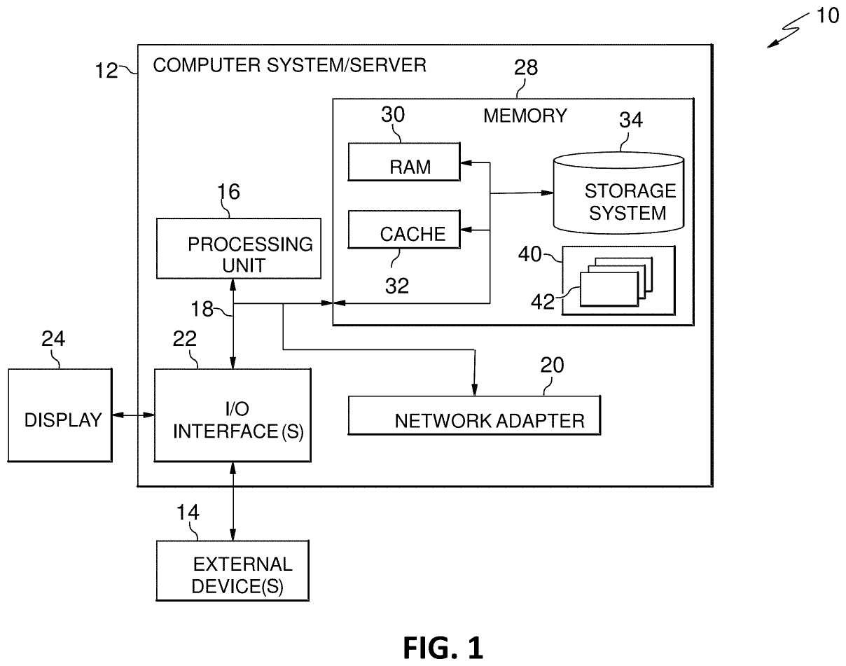

Referring now to FIG. 1, a schematic of an example of a computing infrastructure is shown. Computing infrastructure 10 is only one example of a suitable computing infrastructure and is not intended to suggest any limitation as to the scope of use or functionality of embodiments of the invention described herein. Regardless, computing infrastructure 10 is capable of being implemented and/or performing any of the functionality set forth hereinabove.

In computing infrastructure 10 there is a computer system (or server) 12, which is operational with numerous other general purpose or special purpose computing system environments or configurations. Examples of well-known computing systems, environments, and/or configurations that may be suitable for use with computer system 12 include, but are not limited to, personal computer systems, server computer systems, thin clients, thick clients, hand-held or laptop devices, multiprocessor systems, microprocessor-based systems, set top boxes, programmable consumer electronics, network PCs, minicomputer systems, mainframe computer systems, and distributed cloud computing environments that include any of the above systems or devices, and the like.

Computer system 12 may be described in the general context of computer system executable instructions, such as program modules, being executed by a computer system. Generally, program modules may include routines, programs, objects, components, logic, data structures, and so on that perform particular tasks or implement particular abstract data types. Computer system 12 may be practiced in distributed cloud computing environments where tasks are performed by remote processing devices that are linked through a communications network. In a distributed cloud computing environment, program modules may be located in both local and remote computer system storage media including memory storage devices.

As shown in FIG. 1, computer system 12 in computing infrastructure 10 is shown in the form of a general-purpose computing device. The components of computer system 12 may include, but are not limited to, one or more processors or processing units (e.g., CPU) 16, a system memory 28, and a bus 18 that couples various system components including system memory 28 to processor 16.

Bus 18 represents one or more of any of several types of bus structures, including a memory bus or memory controller, a peripheral bus, an accelerated graphics port, and a processor or local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnects (PCI) bus.

Computer system 12 typically includes a variety of computer system readable media. Such media may be any available media that is accessible by computer system 12, and it includes both volatile and non-volatile media, removable and non-removable media.

System memory 28 can include computer system readable media in the form of volatile memory, such as random access memory (RAM) 30 and/or cache memory 32. Computer system 12 may further include other removable/non-removable, volatile/non-volatile computer system storage media. By way of example only, storage system 34 can be provided for reading from and writing to a nonremovable, non-volatile magnetic media (not shown and typically called a “hard drive”). Although not shown, a magnetic disk drive for reading from and writing to a removable, non-volatile magnetic disk (e.g., a “floppy disk”), and an optical disk drive for reading from or writing to a removable, non-volatile optical disk such as a CD-ROM, DVD-ROM or other optical media can be provided. In such instances, each can be connected to bus 18 by one or more data media interfaces. As will be further depicted and described below, memory 28 may include at least one program product having a set (e.g., at least one) of program modules that are configured to carry out the functions of embodiments of the invention.

Program/utility 40, having a set (at least one) of program modules 42, may be stored in memory 28 by way of example, and not limitation, as well as an operating system, one or more application programs, other program modules, and program data. Each of the operating system, one or more application programs, other program modules, and program data or some combination thereof, may include an implementation of a networking environment. Program modules 42 generally carry out the functions and/or methodologies of embodiments of the invention as described herein.

Computer system 12 may also communicate with one or more external devices 14 such as a keyboard, a pointing device, a display 24, etc.; one or more devices that enable a user to interact with computer system 12; and/or any devices (e.g., network card, modem, etc.) that enable computer system 12 to communicate with one or more other computing devices. Such communication can occur via Input/Output (I/O) interfaces 22. Still yet, computer system 12 can communicate with one or more networks such as a local area network (LAN), a general wide area network (WAN), and/or a public network (e.g., the Internet) via network adapter 20. As depicted, network adapter 20 communicates with the other components of computer system 12 via bus 18. It should be understood that although not shown, other hardware and/or software components could be used in conjunction with computer system 12. Examples, include, but are not limited to: microcode, device drivers, redundant processing units, external disk drive arrays, RAID systems, tape drives, and data archival storage systems, etc.

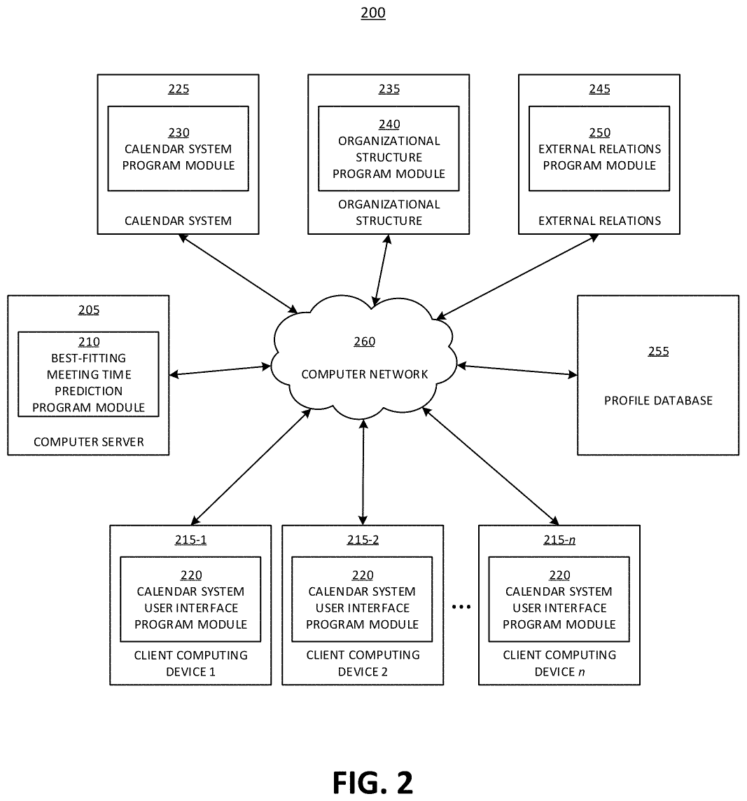

FIG. 2 depicts an illustrative environment 200 in accordance with aspects of the invention. As shown, the environment 200 comprises a computer server 205, a plurality of client computing devices 215-1, 215-2, . . . , 215-n, calendar system 225, organizational structure 235, external relations 245, and profile database 255 which are in communication via a computer network 260. In embodiments, the computer network 260 is any suitable network including any combination of a LAN, WAN, or the Internet. In embodiments, the computer server 205, the plurality of client computing devices 215-1, 215-2, . . . , 215-n, the calendar system 225, the organizational structure 235, the external relations 245, and the profile database 255 are physically collocated, or, more typically, are situated in separate physical locations.

The quantity of devices and/or networks in the environment 200 is not limited to what is shown in FIG. 2. In practice, the environment 200 may include additional devices and/or networks; fewer devices and/or networks; different devices and/or networks; or differently arranged devices and/or networks than illustrated in FIG. 2. Also, in some implementations, one or more of the devices of the environment 200 may perform one or more functions described as being performed by another one or more of the devices of the environment 200.

In embodiments, the computer server 205 is a computer device comprising one or more elements of the computer system/server 12 (as shown in FIG. 1). In particular, the computer server 205 is implemented as hardware and/or software using components such as mainframes; RISC (Reduced Instruction Set Computer) architecture based servers; servers; blade servers; storage devices; networks and networking components; virtual servers; virtual storage; virtual networks, including virtual private networks; virtual applications and operating systems; and virtual clients.

In embodiments, the computer server 205 includes a best-fitting meeting time prediction program module 210, which comprises one or more of the program modules 42 shown in FIG. 1. In embodiments, the best-fitting meeting time prediction program module 210 includes program instructions for best-fitting meeting time prediction by ad-hoc ensemble creation for personalized classification with a group scope. In embodiments, the program instructions included in the best-fitting meeting time prediction program module 210 of the computer server 205 are executed by one or more hardware processors.

Still referring to FIG. 2, in embodiments, each of the plurality of user computing devices 215-1, 215-2, . . . , 215-n is a computer device comprising one or more elements of the computer system/server 12 (as shown in FIG. 1). In other embodiments, each of the plurality of user computing devices 215-1, 215-2, . . . , 215-n is a desktop computer, a laptop computer, a mobile device such as a cellular phone, tablet, personal digital assistant (PDA), or other computing device.

In embodiments, each of the plurality of user computing devices 215-1, 215-2, . . . , 215-n includes calendar system user interface program module 220, which comprises one or more of the program modules 42 shown in FIG. 1. In embodiments, the calendar system user interface program module 220 includes program instructions for a user interface for the calendar system 225. In embodiments, the program instructions included in the calendar system user interface program module 220 of each of the plurality of user computing devices 215-1, 215-2, . . . , 215-n are executed by one or more hardware processors.

Still referring to FIG. 2, in embodiments, the calendar system 225 is a computer device comprising one or more elements of the computer system/server 12 (as shown in FIG. 1). In particular, the calendar system 225 is implemented as hardware and/or software using components such as mainframes; RISC (Reduced Instruction Set Computer) architecture based servers; servers; blade servers; storage devices; networks and networking components; virtual servers; virtual storage; virtual networks, including virtual private networks; virtual applications and operating systems; and virtual clients.

In embodiments, the calendar system 225 includes a calendar system program module 230, which comprises one or more of the program modules 42 shown in FIG. 1. In embodiments, the calendar system program module 230 includes program instructions for a calendar system that is accessed by users of the client computing devices 215-1, 215-2, . . . , 215-n using the calendar system user interface program module 220. In embodiments, the program instructions included in the calendar system program module 230 of the calendar system 225 are executed by one or more hardware processors.

Still referring to FIG. 2, in embodiments, the organizational structure 235 is a computer device comprising one or more elements of the computer system/server 12 (as shown in FIG. 1). In particular, the organizational structure 235 is implemented as hardware and/or software using components such as mainframes; RISC (Reduced Instruction Set Computer) architecture based servers; servers; blade servers; storage devices; networks and networking components; virtual servers; virtual storage; virtual networks, including virtual private networks; virtual applications and operating systems; and virtual clients. In other embodiments, the organizational structure 235 is a server that provides an organizational directory, such as an LDAP server.

In embodiments, the organizational structure 235 includes an organizational structure program module 240, which comprises one or more of the program modules 42 shown in FIG. 1. In embodiments, the organizational structure program module 240 includes program instructions for providing information about an organizational structure in response to a request. In embodiments, the program instructions included in the organizational structure program module 240 of the organizational structure 235 are executed by one or more hardware processors.

Still referring to FIG. 2, in embodiments, the external relations 245 is a computer device comprising one or more elements of the computer system/server 12 (as shown in FIG. 1). In particular, the external relations 245 is implemented as hardware and/or software using components such as mainframes; RISC (Reduced Instruction Set Computer) architecture based servers; servers; blade servers; storage devices; networks and networking components; virtual servers; virtual storage; virtual networks, including virtual private networks; virtual applications and operating systems; and virtual clients. In other embodiments, the external relations 245 is a server that provides information about external relationships, such as a CRM server.

In embodiments, the external relations 245 includes an external relations program module 250, which comprises one or more of the program modules 42 shown in FIG. 1. In embodiments, the external relations program module 250 includes program instructions for providing information about external relationships in response to a request. In embodiments, the program instructions included in the external relations program module 250 of the external relations 245 are executed by one or more hardware processors.

Still referring to FIG. 2, in embodiments, the profile database 255 is a database that stores profiles for a plurality of users of the calendar system 225. In embodiments, the profile database 255 is implemented as hardware and/or software using components such as mainframes; RISC (Reduced Instruction Set Computer) architecture based servers; servers; blade servers; storage devices; networks and networking components; virtual servers; virtual storage; virtual networks, including virtual private networks; virtual applications and operating systems; and virtual clients.

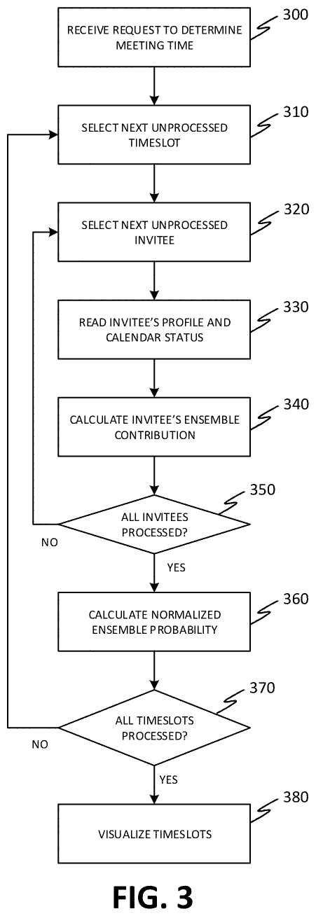

FIG. 3 depicts a flowchart of an exemplary method performed by the best-fitting meeting time prediction program module 210 of the computer server 205 in accordance with aspects of the invention. The steps of the method are performed in the environment of FIG. 2 and are described with reference to the elements shown in FIG. 2.

At step 300, the computer server 205 receives a request to determine a meeting time. In embodiments, step 300 comprises the best-fitting meeting time prediction program module 210 of the computer server 205 receiving the request to determine the meeting time from the calendar system user interface program module 220 of one of the client computing devices 215-1, 215-2, . . . , 215-n or from the calendar system program module 230 of the calendar system 225.

Still referring to step 300, in embodiments, a user of one of the client computing devices 215-1, 215-2, . . . , 215-n uses a user interface provided by the calendar system user interface program module 220 to create an invitation for a new meeting. In embodiments, an option is provided in the user interface to determine a best-fitting meeting time for the new meeting. In response to the user selecting this option in the user interface, the calendar system user interface program module 220 sends the request to determine the meeting time to the best-fitting meeting time prediction program module 210 of the computer server 205, either directly or via the calendar system program module 230 of the calendar system 225. In embodiments, the request includes a list of invitees for the new meeting (e.g., names, email addresses, usernames, and/or user ids, etc.) as well as information (e.g., name, email address, username, and/or user id, etc.) about the user (i.e., the meeting requester/organizer).

Still referring to step 300, in other embodiments, in response to receiving the request, the best-fitting meeting time prediction program module 210 of the computer server 205 optionally retrieves, from the profile database 255, the profile of the meeting requester specified in the received request. In embodiments, information included in the retrieved profile may include weights for each of a plurality of meeting invitees. The weight for each meeting invitee reflects a view of the meeting requester on the importance of participation by the invitee in a meeting requested by the meeting requester.

Still referring to FIG. 3, at step 310, the computer server 205 selects a next unprocessed timeslot. In embodiments, step 310 comprises the best-fitting meeting time prediction program module 210 of the computer server 205 selecting the next unprocessed timeslot from a list of potential (candidate) timeslots for the new meeting, the timeslots starting from a present time and extending a predetermined amount of time into the future. In an example, the predetermined amount of time is one week, and the list of timeslots starts from the present time and extends one week into the future.

Still referring to step 310, in embodiments, each timeslot is a predetermined length (e.g., 15 minutes, 30 minutes, or 60 minutes). In other embodiments, each timeslot is a length equal to a meeting length that is specified (e.g., by a user/meeting requester) in the user interface presented by the calendar system user interface program module 220 of one of the client computing devices 215-1, 215-2, . . . , 215-n. The specified meeting length may be included in the request received at step 300.

Still referring to FIG. 3, at step 320, the computer server 205 selects a next unprocessed invitee i. In embodiments, step 320 comprises the best-fitting meeting time prediction program module 210 of the computer server 205 selecting the next unprocessed invitee i from the list of invitees for the new meeting received with the request at step 300.

Still referring to FIG. 3, at step 330, the computer server 205 reads the invitee's profile and calendar status. In embodiments, step 330 comprises the best-fitting meeting time prediction program module 210 of the computer server 205 retrieving, from the profile database 255, the profile of the invitee i selected at step 320. Additionally, in embodiments, step 330 comprises the best-fitting meeting time prediction program module 210 of the computer server 205 retrieving, from the calendar system 225, using the calendar system program module 230, the calendar status of the invitee selected at step 320, including free/busy information (e.g., information about currently scheduled meetings (availability information)). In embodiments, the free/busy information retrieved is an argument Ψ that indicates whether the timeslot selected at step 310 is free (Ψ=1) or busy (Ψ=0) and a weight ε of an already booked (busy) timeslot (e.g., an importance of the already booked timeslot). (In embodiments, if the timeslot is free, ε=0.)

Still referring to step 330, in embodiments, information included in the retrieved profile may include weights for a plurality of meeting requesters, including a weight Θ for the particular meeting requester specified in the request received at step 300. The weight Θ reflects an importance of participation by the invitee in a meeting requested by the particular meeting requester. In embodiments, if the profile information does not include the weight Θ for the particular meeting requester specified in the request received at step 300, the weight Θ is automatically determined based upon information about an organizational relationship between the invitee and the meeting requester obtained from the organizational structure program module 240 of the organizational structure 325 and/or information about an external relationship between the invitee and the meeting requester obtained from the external relations program module 250 of the external relations 245. In embodiments, the best fitting meeting time prediction program module 210 automatically creates or updates the profiles of the invitees in the profile database 255 (e.g., in a background process) to include metadata such as the determined weight Θ for the particular meeting requester.

Still referring to step 330, in an example, the weights range from 0 to 1, and a relatively higher weight Θ may be assigned if the organizational relationship (determined based on the information obtained from the organizational structure 325) is relatively closer (e.g., “is my boss”, “is reporting to me”, “is working with me on the same project (peer)”, etc.), and a relatively lower weight Θ may be assigned if the organizational relationship is relatively more distant (e.g., “is not my boss”, “is not reporting to me”, “is not working with me on the same project (not peer)”, etc.). In another example, a relatively higher weight Θ may be assigned if the external relationship (determined based on the information obtained from the external relations 245) is relatively closer (e.g., “is my customer (I'm an advocate of)”, etc.), and a relatively lower weight Θ may be assigned if the external relationship is relatively more distant (e.g., “is not my customer (I'm not an advocate of)”, etc.).

In other embodiments, the weight Θ for the meeting requester is optionally adjusted (e.g., using the calendar system user interface program module 220 on one of the client computing devices 215-1, 215-2, . . . , 215-n), by the invitee based upon a subjective view of the invitee on the importance of meetings requested by the meeting requester.

Still referring to FIG. 3, at step 340, the computer server 205 calculates the ensemble contribution for the invitee i. In embodiments, step 340 comprises the best-fitting meeting time prediction program module 210 of the computer server 205 calculating the ensemble contribution for the invitee i selected at step 320 for the timeslot selected at step 310 using the weight Θ for the meeting requester and the weight c for an already booked timeslot determined at step 330, according to Formula 7, where LOW is the lowest (positive) value of Θ and ε and HIGH is the highest (positive) value of Θ and ε:

((Θᵢ−εᵢ)+HIGH−LOW)/(2*HIGH−LOW)) Formula 7

Still referring to step 340, the ensemble contribution calculated according to Formula 7 is added to the ensemble value for the timeslot. In the case where the calculated ensemble contribution is for the first invitee for the timeslot, then the ensemble value for the timeslot is set to the calculated ensemble contribution.

Still referring to FIG. 3, at step 350, the computer server 205 determines whether or not all invitees have been processed. In embodiments, step 350 comprises the best-fitting meeting time prediction program module 210 of the computer server 205 determining whether or not all invitees from the list of invitees for the new meeting received with the request at step 300 have been processed. If the best-fitting meeting time prediction program module 210 determines that not all invitees have been processed, then the flow returns to step 310. On the other hand, if the best-fitting meeting time prediction program module 210 determines that all invitees have been processed, then the flow proceeds to step 360.

Still referring to FIG. 3, at step 360, the computer server 205 calculates a normalized ensemble probability. In embodiments, step 360 comprises the best-fitting meeting time prediction program module 210 of the computer server 205 normalizing the ensemble value for the timeslot determined at step 340 by dividing the ensemble value by the number of invitees in the list of invitees received at step 300. In this way, the best-fitting meeting time prediction program module 210 determines a normalized ensemble value for the timeslot which is in the range of 0 to 1. This normalized ensemble value is a meeting participation probability (e.g., a probability of the invitees attending the meeting scheduled for the timeslot).

Still referring to step 360, in other embodiments, when the profile of the meeting requester is retrieved at step 300 and includes weights for each of the plurality of meeting invitees, the calculation of the normalized ensemble probability takes into account these weights, such that invitees whose participation is more important contribute more to the normalized ensemble probability.

Still referring to FIG. 3, at step 370, the computer server 205 determines whether or not all timeslots have been processed. In embodiments, step 370 comprises the best-fitting meeting time prediction program module 210 of the computer server 205 determining whether or not all timeslots from the list of potential (candidate) timeslots from step 310 have been processed. If the best-fitting meeting time prediction program module 210 determines that not all timeslots have been processed, then the flow returns to step 310. On the other hand, if the best-fitting meeting time prediction program module 210 determines that all timeslots have been processed, then the flow proceeds to step 380.

Still referring to FIG. 3, at step 380, the computer server 205 visualizes the timeslots. In embodiments, step 380 comprises the best-fitting meeting time prediction program module 210 of the computer server 205 causing the calendar system user interface program module 220 of one of the client computing devices 215-1, 215-2, . . . , 215-n to display, on a user interface, a visual indication of the meeting participation probability determined at step 360 for each of the timeslots in the list of potential (candidate) timeslots from step 310. In embodiments, as a response to the request received at step 300, the best-fitting meeting time prediction program module 210 returns the meeting participation probability for each of the timeslots in the list of potential (candidate) timeslots to the calendar system user interface program module 220 of one of the client computing devices 215-1, 215-2, . . . , 215-n, and in response to receiving this information, the calendar system user interface program module 220 displays the visual indication of the meeting participation for each of the timeslots on the user interface.

Still referring to step 380, in an example, the potential (candidate) timeslots are categorized into a group having a highest meeting participation probability, a group having an intermediate meeting participation probability, and a group having a lowest meeting participation probability, either based on predefined ranges (e.g., 0 to 0.25=low, 0.25 to 0.75=medium, 0.75 to 1=high) or by selecting a predetermined number or portion of the timeslots having the highest probabilities for each of the groups. In other examples, any number of groups (e.g., five groups) and/or different predefined ranges (e.g., 0 to 0.2=first group, 0.21 to 0.4=second group, 0.41 to 0.6=third group, 0.61 to 0.8=fourth group, and 0.81 to 1=fifth group) may be used. In the example, in the user interface, each of the meeting timeslots in the high group is displayed with a first color or shading (e.g., a white background), each of the meeting timeslots in the intermediate group is displayed with a second color or shading (e.g., a shaded background), and each of the meeting timeslots in the low group is displayed with a third color or shading (e.g., a solid background). In other examples, any number of different colors and/or shadings may be used to visualize the groups in the user interface.

Still referring to step 380, in embodiments, a user of the client computing device 215-1, 215-2, . . . , 215-n selects one of the timeslots for the meeting. In other embodiments, the calendar system user interface program module 220 automatically selects a timeslot having a highest meeting participation probability among the list of potential (candidate) timeslots. Optionally, the calendar system user interface program module 220 requests that the user confirm or reject the automatically selected timeslot. In response to the selection of the timeslot for the meeting, the calendar system user interface program module 220 causes the calendar system program module 230 to send meeting invitations to the invitees.

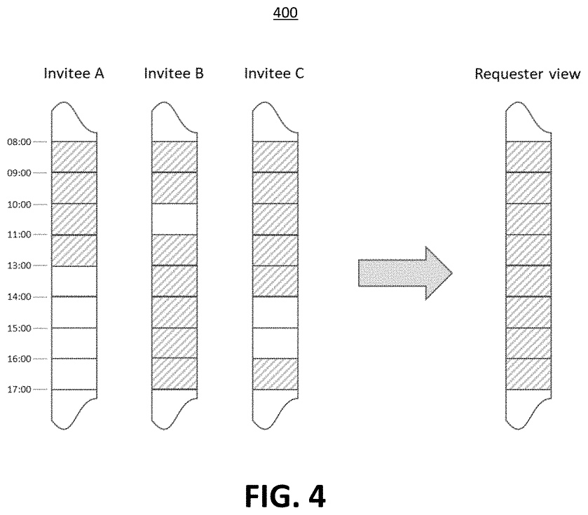

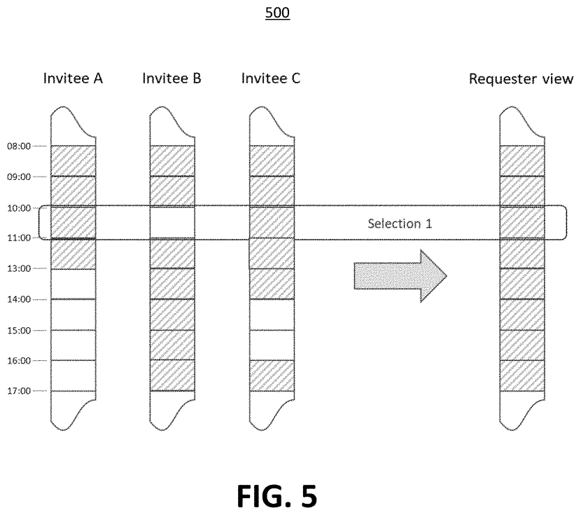

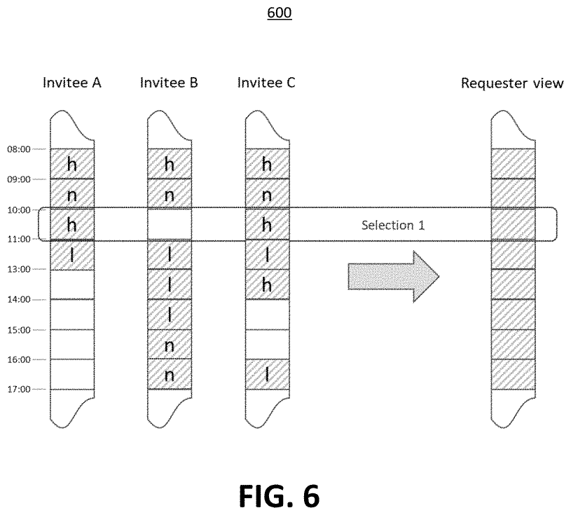

In an example, a conventional system (illustrated in FIGS. 4 and 5) is compared with an exemplary system according to an embodiment (illustrated in FIGS. 6, 7, and 8). In the example, there are three invitees to a new meeting and three weighting levels (HIGH, NORMAL, LOW). A person searching for a suitable timeslot for scheduling the new meeting is named “Requester”, and the persons on his/her invitee list are named “Invitee A”, “Invitee B”, and “Invitee C”.

In the example, FIG. 4 illustrates an example of a visualization of potential meeting timeslots 400 that is displayed to “Requester” in a conventional system. Although the individual calendar information of the three persons on the invitee list reveals some individual free timeslots, due to the overlap of the already booked meetings, the summary view (Requester view) does not indicate any recommendation for a best fitting meeting time throughout the normal working hours. In this conventional scenario, as illustrated in FIG. 5, Requester chooses “Selection 1” based on the visualization of potential meeting timeslots 500, without knowing that “Invitee C” will most probably not accept the meeting request. However, if Requester had information about the individual importance of the already booked meetings of Invitee A, Invitee B, and Invitee C, then Requester could select a better-fitting timeslot for the new meeting to be scheduled.

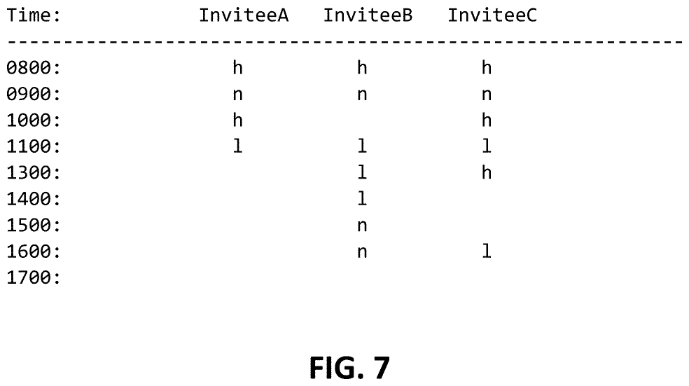

Continuing with the example, to address the above-mentioned shortcoming of the conventional system illustrated in FIGS. 4 and 5, in an exemplary system according to an embodiment, a limited weighting granularity is used, with three weights set: “HIGH (H)=10”, “NORMAL (N)=5”, and “LOW (L)=1”. According to these three weighting levels, the following are defined: Θ is the invitee's weight regarding the personal importance of the requester and can be set as either “H” (10), “N” (5), or “L” (1); ε is the invitee's weight assigned to an already booked meeting in the invitee's calendar and can be set as either “h” (10), “n” (5), or “l” (1). This is illustrated in FIG. 6, which shows the relative importance of the already accepted meeting invitations (from the same or other requesters) by each invitee on the visualization of potential meeting timeslots 600. In embodiments, a computer program prints the invitee profiles showing the relative importance of the already accepted meeting inventions, as shown in the table in FIG. 7.

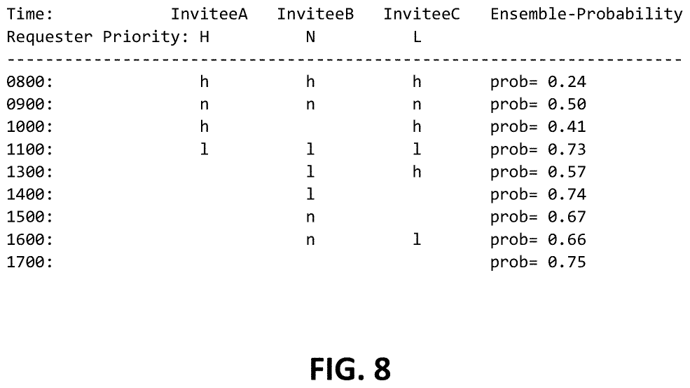

Continuing with the example, in embodiments, to find the optimal fitting meeting timeslot for all invitees, the relative importance of the requester with is considered with respect to each invitee, which is stored in each invitee's profile, and then the ensemble probabilities for each timeslot are calculated. In embodiments, a computer program prints the ensemble probabilities as shown in the table in FIG. 8.

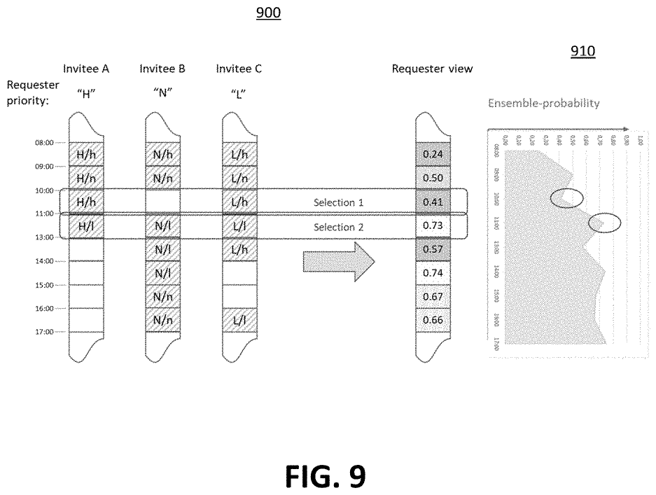

Continuing with the example, as shown in the calculated result 910 in FIG. 9, the first chosen timeslot at 10:00 (Selection 1) is not the best one, although only two out of three invitees are booked. In embodiments, based on the ensemble probabilities, a recommendation is made for the timeslot at 11:00 (Selection 2) on the visualization of potential meeting timeslots 900. Here, although all of the three invitees of Selection 2 are booked already, based on the calculation which takes into account the relative importance between Requester and the already booked meetings, it is determined that the timeslot at 11:00 has a much higher ensemble probability than the timeslot at 10:00 (Selection 2: 0.73 versus Selection 1: 0.41). Accordingly, instead of only displaying “booked” or “free” for potential meeting timeslots, in embodiments, shading or coloring levels are used to assist Requester in easily finding the best-fitting timeslot, as shown in the visualization of potential meeting timeslots 900. In embodiments, for privacy reasons, individual importance settings for each invitee for each booked meeting may not be shown. In other embodiments, individual importance settings are exposed to all requesters or only to specified requesters, based upon a setting selected by each invitee.

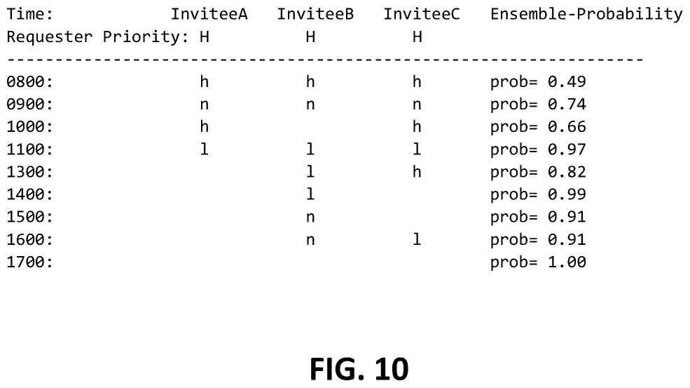

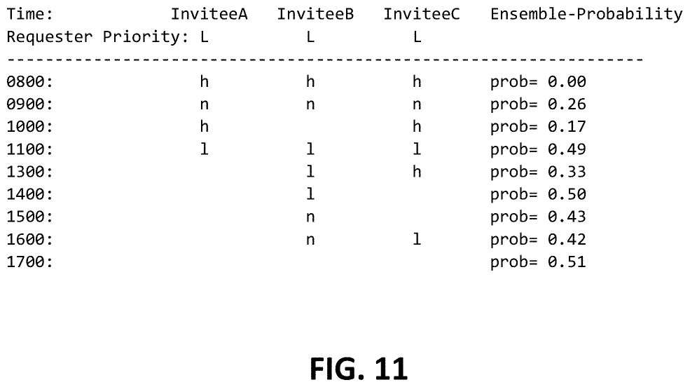

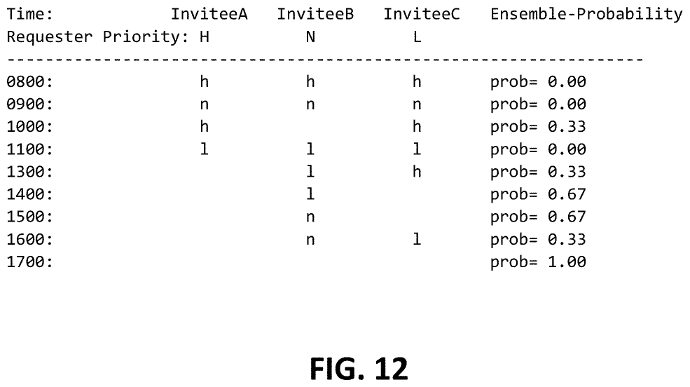

FIGS. 10, 11, and 12 show variations in the relative priority of the Requester per invitee to visualize the range of the possible results. In FIG. 9, a computer program prints the ensemble probability results in the case where “Requester” importance is HIGH for all three invitees, according to an embodiment. In FIG. 10, a computer program prints the ensemble probability results in the case where “Requester” importance is LOW for all three invitees, according to an embodiment. In FIG. 11, a computer program prints the ensemble probability results in the “unweighted” case, i.e., all weights are equal (“H”=“N”=“L” and “h”=“n”=“1”). In this case, in embodiments, the ensemble probability results are based on the ratio of booked and free timeslots of all invitees. In an example, if all three invitees are booked at a timeslot, then the ensemble probability is “0”; if one invitee is booked, then the probability is “0.33”; if two invitees are booked, then the probability is “0.66”; and if all three invitees are free, then the probability is “1”.

Accordingly, it is understood from the foregoing description that embodiments of the invention provide a method for determining an optimal timeslot of a meeting in a social collaboration application, the method comprising: defining the participants of the meeting by one of the participants (inviter); defining the roles of the participants of the meeting by one of the participants (inviter); weighting the roles manually or automatically using the metadata of the participants; using collaboration metadata of the participants (inviter and invitee) for calculating a probability that reflect the likeliness to attend the meeting of the participants; defining the best available timeslot by using an additional analysis of the metadata wherein the selected timeslot fits best to the scope of the planned collaboration; presenting a result list to one of the participants (inviter); choosing one or more timeslots out of the result list; and triggering the invitation of the participants (manually or automatically) with the selected timeslot of the meeting.

Additionally, it is understood from the foregoing description that embodiments of the invention provide a method for automatically creating a database in the background with the metadata, including all available data about the participants in a connected computer system, including their roles and responsibilities in an entity and contributions to a particular meeting; grouping of participants depending on a selection by the inviter or a task or a project; and providing the option to the participants for manual overriding of the metadata, such as expressing personal assessment about own personal benefits of particular meetings and type of meetings and meeting requesters, respectively.

In embodiments, a service provider could offer to perform the processes described herein. In this case, the service provider can create, maintain, deploy, support, etc., the computer infrastructure that performs the process steps of the invention for one or more customers. These customers may be, for example, any business that uses cloud computing technology. In return, the service provider can receive payment from the customer(s) under a subscription and/or fee agreement and/or the service provider can receive payment from the sale of advertising content to one or more third parties.

In still additional embodiments, the invention provides a computer-implemented method, via a network. In this case, a computer infrastructure, such as computer system/server 12 (FIG. 1), can be provided and one or more systems for performing the processes of the invention can be obtained (e.g., created, purchased, used, modified, etc.) and deployed to the computer infrastructure. To this extent, the deployment of a system can comprise one or more of: (1) installing program code on a computing device, such as computer system/server 12 (as shown in FIG. 1), from a computer-readable medium; (2) adding one or more computing devices to the computer infrastructure; and (3) incorporating and/or modifying one or more existing systems of the computer infrastructure to enable the computer infrastructure to perform the processes of the invention.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A computer-implemented method comprising:
receiving, by a computing device, a request to determine a timeslot for a meeting, the request comprising a plurality of invitees and information about a meeting requester;
reading, by the computing device, for each of the plurality of invitees, information about currently scheduled meetings and a profile comprising a weight assigned to the meeting requester;
determining, by the computing device, for each of a plurality of candidate timeslots, an ensemble value for the candidate timeslot based on the information about the currently scheduled meetings and the weight assigned to the meeting requester for each of the plurality of invitees; and
selecting, by the computing device, the timeslot for the meeting based on the ensemble values for the candidate timeslots.

2. The computer-implemented method according to claim 1, wherein, for each of the plurality of candidate timeslots, the ensemble value is a probability of the plurality of invitees attending the meeting at the candidate timeslot.

3. The computer-implemented method according to claim 2, wherein the selecting the timeslot comprises automatically selecting the timeslot based on a highest ensemble value.

4. The computer-implemented method according to claim 1, wherein the determining the ensemble value for the candidate timeslot comprises:
for each of the plurality of invitees, the computing device calculating an ensemble contribution based on the information about the currently scheduled meetings for the invitee and the weight assigned to the meeting requester for the invitee; and
determining, by the computing device, the ensemble value by summing the ensemble contributions for the plurality of invitees.

5. The computer-implemented method according to claim 1, wherein, for each of the plurality of invitees, the weight assigned to the meeting requester for the invitee is based on an organizational relationship between the invitee and the meeting requester.

6. The computer-implemented method according to claim 5, wherein, for each of the plurality of invitees, the weight assigned to the meeting requester for the invitee is adjusted based on a subjective view of the invitee on an importance of meetings requested by the meeting requester.

7. The computer-implemented method according to claim 1, wherein, for each of the plurality of invitees, the weight assigned to the meeting requester for the invitee is based on an external relationship between the invitee and the meeting requester.

8. A computer program product comprising a computer readable storage medium having program instructions embodied therewith, the program instructions executable by a computing device to cause the computing device to:
receive a request to determine a timeslot for a meeting, the request comprising a plurality of invitees and information about a meeting requester;
for each of the plurality of invitees, read information about currently scheduled meetings and a profile comprising a weight assigned to the meeting requester;
for each of a plurality of candidate timeslots, determine an ensemble value for the candidate timeslot based on the information about the currently scheduled meetings and the weight assigned to the meeting requester for each of the plurality of invitees; and
display, in a user interface, an indication of a meeting participation probability for each of the plurality of candidate timeslots based on the ensemble values.

9. The computer program product according to claim 8, wherein, for each of the plurality of candidate timeslots, the ensemble value is a probability of the plurality of invitees attending the meeting at the candidate timeslot.

10. The computer program product according to claim 9, the program instructions further being executable by the computing device to cause the computing device to categorize the plurality of candidate timeslots into at least three groups, including a first group having a highest meeting participation probability, a second group having an intermediate meeting participation probability, and a third group having a lowest meeting participation probability.

11. The computer program product according to claim 10, wherein the displaying the indication of the meeting participation probability comprises using a first color or shading in the user interface to indicate the first group, using a second color or shading in the user interface to indicate the second group, and using a third color or shading in the user interface to indicate the third group.

12. The computer program product according to claim 8, wherein the determining the ensemble value for the candidate timeslot comprises:
for each of the plurality of invitees, the computing device calculating an ensemble contribution based on the information about the currently scheduled meetings for the invitee and the weight assigned to the meeting requester for the invitee; and
determining, by the computing device, the ensemble value by summing the ensemble contributions for the plurality of invitees.

13. The computer program product according to claim 8, wherein, for each of the plurality of invitees, the weight assigned to the meeting requester for the invitee is based on an organizational relationship between the invitee and the meeting requester.

14. The computer program product according to claim 13, wherein, for each of the plurality of invitees, the weight assigned to the meeting requester for the invitee is adjusted based on a subjective view of the invitee on an importance of meetings requested by the meeting requester.

15. The computer program product according to claim 8, wherein, for each of the plurality of invitees, the weight assigned to the meeting requester for the invitee is based on an external relationship between the invitee and the meeting requester.

16. A system comprising:
a hardware processor, a computer readable memory, and a computer readable storage medium associated with a computing device;
program instructions to receive a request to determine a timeslot for a meeting, the request comprising a plurality of invitees and information about a meeting requester;
program instructions to read, for each of the plurality of invitees, information about currently scheduled meetings and a profile comprising a weight assigned to the meeting requester;
program instructions to determine, for each of a plurality of candidate timeslots, an ensemble value for the candidate timeslot based on the information about the currently scheduled meetings and the weight assigned to the meeting requester for each of the plurality of invitees; and
program instructions to select the timeslot for the meeting based on the ensemble values for the candidate timeslots,
wherein the program instructions are stored on the computer readable storage medium for execution by the hardware processor via the computer readable memory.

17. The system according to claim 16, wherein, for each of the plurality of candidate timeslots, the ensemble value is a probability of the plurality of invitees attending the meeting at the candidate timeslot.

18. The system according to claim 17, wherein the selecting the timeslot comprises automatically selecting the timeslot based on a highest ensemble value.

19. The system according to claim 16, wherein the determining the ensemble value for the candidate timeslot comprises:
for each of the plurality of invitees, calculating an ensemble contribution based on the information about the currently scheduled meetings for the invitee and the weight assigned to the meeting requester for the invitee; and
determining the ensemble value by summing the ensemble contributions for the plurality of invitees.

20. The system according to claim 16, wherein, for each of the plurality of invitees, the weight assigned to the meeting requester for the invitee is based on an organizational relationship between the invitee and the meeting requester.
